(19) United States
(12) Patent Application Publication
(10) Pub. No.: US 2014/0147241 A1
(43) Pub. Date: May 29, 2014

(54) TURNOVER MECHANISM

(71) Applicants: HON HAI PRECISION INDUSTRY CO., LTD., New Taipei (TW); FU DING ELECTRONICAL TECHNOLOGY (JIASHAN) CO., LTD, Zhejiang (CN)

(72) Inventors: FA-RONG JIANG, Jiashan (CN); DE-JUN CAO, Jiashan (CN); XI-HUA XU, Jiashan (CN)

(73) Assignees: HON HAI PRECISION INDUSTRY CO., LTD., New Taipei (TW); FU DING ELECTRONICAL TECHNOLOGY (JIASHAN) CO.,LTD., Zhejiang (CN)

(21) Appl. No.: 14/085,798

(22) Filed: Nov. 21, 2013

(30) Foreign Application Priority Data
Nov. 28, 2012 (CN) 2012206377402

(51) Int. Cl. B25J 11/00

(52) U.S. Cl. CPC B25J 11/00
USPC 414/758

(57) ABSTRACT

A turnover mechanism is used for turning a fixture and a workpiece positioned on the fixture, which includes a support bracket, a first turning mechanism, a movement mechanism, and a second turning mechanism. First turning mechanism includes a first rotary driver, a first clamping driver and two first clamping members oppositely positioned on the first clamping driver. The first rotary driver is positioned on the support bracket and connected to the first clamping driver. The first clamping driver drives the first clamping members to clamp the fixture and the workpiece. The first rotary driver rotate the first clamping driver and the two first clamping members to such that the fixture is driven to be rotated on a reverse side. The movement mechanism reaches the first turning mechanism to transfer the workpiece to the second turning mechanism. Second turning mechanism is mounted on the support bracket, clamping and turning the workpiece.

### BACKGROUND

1. Technical Field

The present disclosure relates to a turnover mechanism.

2. Description of Related Art

In industrial production or assembly processes, there is a need to turn over the workpiece in order to process the opposite sides of the workpiece respectively. In general, the workpiece must be turned over by hand. However, the efficiency of turning over of each workpiece by hand is relatively low, and by using this method, it is easy to scratch the surface of the workpiece.

Therefore, there is room for improvement in the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views.

FIG. 1 is an assembled view of the turnover mechanism.

FIG. 2 is an enlarged view of an encircled portion II of FIG. 1.

### DETAILED DESCRIPTION

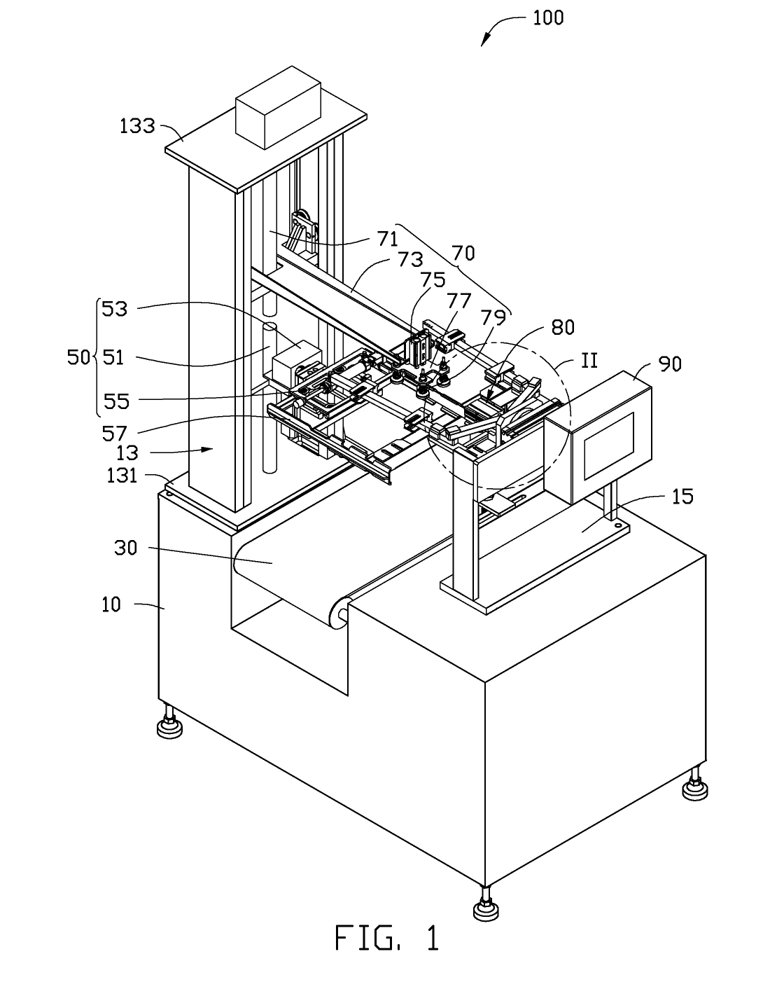

FIG. 1 shows a turnover mechanism 100 of an embodiment. The turnover mechanism 100 is used for turning or flipping over a fixture (not shown) and a workpiece (not shown) positioned on the fixture, respectively, in an automatic production line. The turnover mechanism 100 is positioned between a first processing equipment (not shown) and a second processing equipment (not shown).

The turnover mechanism 100 includes a support bracket 10, a conveyor belt 30, a first turning mechanism 50, a movement mechanism 70, a second turning mechanism 80, and a controller 90. The conveyor belt 30, is positioned on the support bracket 10, and is configured for carrying the fixture and the workpiece positioned on the fixture from the first processing equipment to the second processing equipment. The first turning mechanism 50 is positioned on the support bracket 10. The first turning mechanism 50 is capable of moving up and down in a straight line relative to the conveyor belt 30 to clamp the fixture and the workpiece positioned on the fixture, and is capable of turning (or rotating) the fixture. The movement mechanism 70 is positioned on the support bracket 10 and above the first turning mechanism 50. The movement mechanism 70 is capable of moving up and down in a straight line relative to the conveyor belt 30, and is configured for grabbing the workpiece from the first turning mechanism 50 by suction. The second turning mechanism 80 is positioned on the support bracket 10 opposite to the first turning mechanism 50, while the conveyer belt 30 is positioned between the first turning mechanism 50 and the second turning mechanism 80. The second turning mechanism 80 is configured for clamping the workpiece from the movement mechanism 70 and turning (or rotating) the workpiece upon clamping thereof. The controller 90 is mounted adjacent to the second turning mechanism 80 on the support bracket 10. The controller 90 is electrically connected with the first turning mechanism 50, the movement mechanism 70 and the second turning mechanism 80, respectively, to control the turnover mechanism 100.

The support bracket 10 includes a base 11, a first support frame 13 and a second support frame 15 positioned on two opposite sides of the base 11. The first support frame 13 includes a first fixing plate 131 and a second fixing plate 133 spaced from the first fixing plate 131. The second fixing plate 133 is located above the first fixing plate 131. The first fixing plate 131 is fixed on the support bracket 10, while the second fixing plate 133 is away from the support bracket 10. The conveyor belt 30 is positioned on the base 11, and between the first support frame 13 and the second support frame 15.

The first turning mechanism 50 includes a first driver 51, a first rotary driver 53, a first clamping driver 55, and two first clamping members 57. The first driver 51 is fixed on the first fixing plate 131 of the first support frame 13, and is received in the first support frame 13. The first rotary driver 53 is fixedly connected with the first driver 51. The first clamping driver 55 is movably-connected with the first rotary driver 53. The two first clamping members 57 are positioned on two opposite sides of the first clamping driver 55, away from the first rotary driver 53 and above the conveyor belt 30. The first driver 51 is configured to drive the first rotary driver 53, the first clamping driver 55 and the two first clamping members 57 to rotate, such that the fixture will be driven to be turned over on a reverse side of the fixture. The first clamping driver 55 is capable of driving the two first clamping members 57 to open or close, thereby releasing or clamping the fixture.

The movement mechanism 70 includes a second driver 71, an elongation member 73, a suction driver 75, a mounting member 77, and four suction members 79. The second driver 71 of the movement mechanism 70 is fixed on the second fixing plate 133 of the first support frame 13, and is received in the first support frame 13. One end of the elongation member 73 is fixedly-connected with the second driver 71, and the other end of the elongation member 73 extends above the first clamping member 57. The suction driver 75 is fixedly-connected with the end of the elongation member 73, which is away from the first support frame 13, and is positioned above the two first clamping members 57. The mounting member 77 is fixedly-connected with the suction driver 75, and is capable to move up and down in a straight line. The four suction members 79 are vacuum suction members. The suction driver 75 can be omitted, and the mounting member 77 can be omitted. The four suction members 79, spaced from each other, are mounted on the end of the elongation member 73, which extends above the first turning mechanism 50.

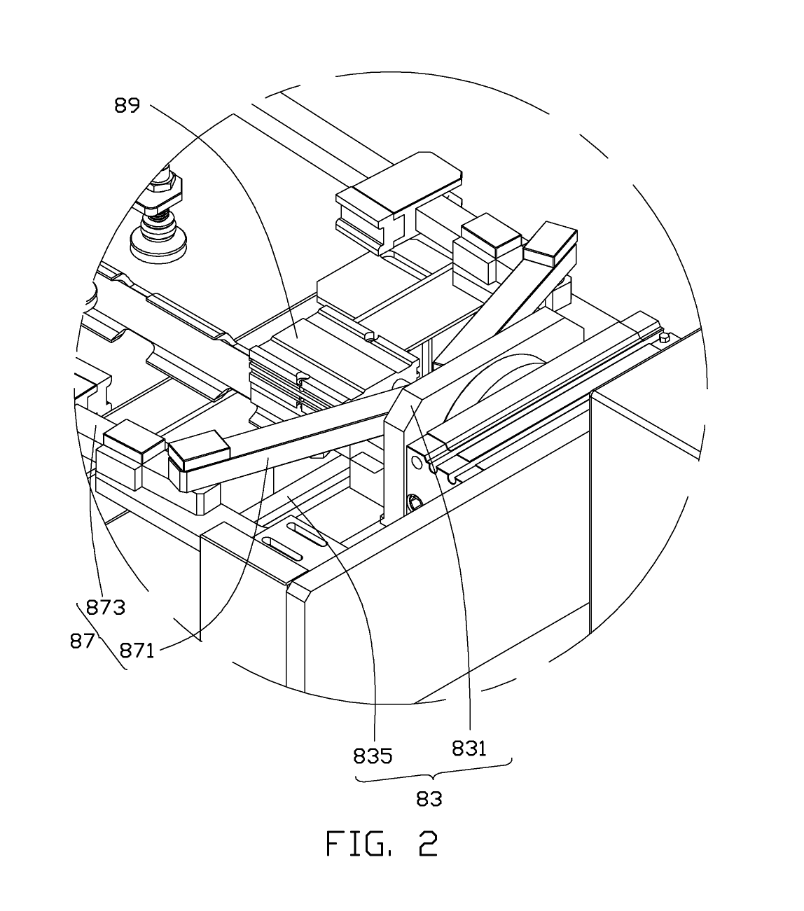

FIG. 2 shows an enlarged view of an encircled portion II of FIG. 1. The second turning mechanism 80 includes a second rotary driver 83, two second clamping members 87, and a second clamping driver 89. The second rotary driver 83 includes a main body 831 and a support member 835. The main body 831 is fixed on the end of the support bracket 10, which is away from the second support frame 15. The two second clamping members 87 are movably-mounted on the two sides of the support member 835. Each second clamping member 87 includes a rod 871 and a clamping jaw 873 connected with the rod 871. The ends of the two second clamping members 87 away from the clamping jaws 873 are mounted on the support member 835 adjacent to the second rotary driver 83 to form a push mechanism (not labeled), thereby forming a connection rod structure (not labeled) by the two second clamping members 87. The end of the clamping jaw 873, which is away from the rod 871, is extending beyond the support member 835 and above the first turning mechanism 50. The second clamping driver 89 is fixed on the center of the support member 835. The second clamping driver 89 is fixedly-connected with the push mechanism, configured for driving the two rods 871 to open or close, and thereby the clamping claws 873 are moved to release or clamp the workpiece. It is understood that, the second rotary driver 83 may have the same structure as the first rotary driver 53, the second clamping member 87 may have the same structure as the first clamping member 57, and the second clamping driver 89 may have the same structure as the first clamping driver 55.

The controller 90 is mounted on the second support frame 15, adjacent to the second rotary driver 83, while the second support frame 15 is positioned between the controller 90 and the conveyor belt 30.

It is understood that, the work piece and the fixture can be positioned on the support bracket 10 directly, so that the conveyor belt 30 can be omitted.

In assembly, first, the conveyor belt 30 is positioned on the support bracket 10 and below the first clamping member 57. Then, the first turning mechanism 50, the movement mechanism 70 are positioned on the first support frame 13 successively. After that, the second turning mechanism 80 is mounted on the second support frame 15. At last, the controller 90 is mounted on the second turning mechanism 80, adjacent to the second rotary driver 83, and is electrically connected with the first turning mechanism 50, the movement mechanism 70, and the second turning mechanism 80, respectively.

In the initial state, the two first clamping members 57 of the first turning mechanism 50 and the two second clamping members 87 of the second turning mechanism 80 are open. The workpiece and the fixture are transferred from the first processing equipment to the conveyor belt 30. At this time, one side of the workpiece opposite to the conveyor belt 30 has been processed.

The first turning mechanism 50 moves toward the conveyor belt 30 until the first clamping members 57 reach to the two sides of the fixture positioned with the workpiece. Then, the two first clamping members 57 closing to clamp the fixture, as the first turning mechanism 50 moves away from the conveyor belt 30 to a preset position. The movement mechanism 70 moves toward the conveyor belt 30, and reaching above the workpiece. The suction members 79 descends to adsorb or suck the workpiece and separates the workpiece from the fixture. Then, the suction driver 75 returns to the initial position with the suction members 79 and the workpiece. The movement mechanism 70 moves above the second turning mechanism 80. At this time, the workpiece is positioned between the two second clamping members 87. The two second clamping members 87 close (toward each other in an inwardly manner) to clamp the workpiece. The suction member 79 releases the workpiece and moves away from the conveyer belt 30, in order not to interfere with the turning or rotating process of the second turning mechanism 80. The second rotary driver 83 rotates the workpiece 180 degrees, while the first rotary driver 53 rotates the fixture 180 degrees.

After that, the movement mechanism 70 moves toward the conveyor belt 30 until reaching above the workpiece and then sucking the workpiece. The two second clamping members 87 open, and the movement mechanism 70 reaches above the first turning mechanism 50 with the workpiece. The suction members 79 moves downwards and releases the workpiece, thereby having the workpiece after being turned to be positioned with the fixture. The first turning mechanism 50 reaches above the conveyor belt 30 and releases the workpiece. The workpiece and the fixture reach the second processing equipment by the conveyor belt 30 to process the other side of the workpiece.

The first turning mechanism 50 clamps the fixture and the workpiece positioned on the fixture off of the conveyor belt 30, the movement mechanism 70 provides suction to hold the workpiece from the first turning mechanism 50 and conveys the workpiece to the second turning mechanism 80. The fixture and the workpiece are respectively turned or rotated over by the first turning mechanism 50 and the second turning mechanism 80 automatically, so that manufacturing efficiency and the product are improved, and the manpower and material are reduced.

It is believed that the present embodiments and their advantages will be understood from the foregoing description, and it will be apparent that various changes may be made thereto without departing from the spirit and scope of the embodiments or sacrificing all of its material advantages.

What is claimed is:

1. A turnover mechanism, configured for respectively turning over a fixture having a workpiece positioned thereon, comprising:
a support bracket,
a first turning mechanism the first turning mechanism comprises a first rotary driver, a first clamping driver and two first clamping members oppositely positioned on the first clamping driver,
an movement mechanism, and
a second turning mechanism,
wherein the first rotary driver is positioned on the support bracket and connected to the first clamping driver, the first clamping driver is configured to drive the two first clamping members to clamp the fixture and the workpiece, the first rotary driver is configured to rotate the first clamping driver and the two first clamping members, such that the fixture is driven to be turned over on a reversed side thereof, the movement mechanism is capable of reaching the first turning mechanism to suck and transfer the workpiece to the second turning mechanism; the second turning mechanism is mounted on the support bracket for clamping and turning the workpiece.

2. The turnover mechanism as claimed in claim 1, wherein the first turning mechanism comprises at least one first driver to drive the first rotary driver and the two first clamping members to rotate relative to the support bracket.

3. The turnover mechanism as claimed in claim 2, wherein the support bracket comprises a base and a first support frame positioned on the base; and the at least one first driver and the movement mechanism are positioned on and received in the support bracket.

4. The turnover mechanism as claimed in claim 1, wherein the movement mechanism comprises a second driver, an elongation member, and at least one suction member; the elongation member is connected to the second driver, and the end of the elongation member away from the second driver extends above the first turning mechanism, and is connected to the at least one suction member.

5. The turnover mechanism as claimed in claim 4, wherein the movement mechanism further comprises a suction driver and a mounting member, the suction driver is connected to the end of elongation member extending above the first turning mechanism; the mounting member is connected to the suction driver, and the at least one suction member is positioned on the mounting member.

6. The turnover mechanism as claimed in claim 1, wherein the second turning mechanism comprises a second rotary driver, two second clamping members and a second clamping driver; the second rotary driver is positioned on the support bracket opposite to the first turning mechanism; the two second clamping members are positioned on the second rotary driver; the second driver is capably to drive the two second clamping members to clamp and release the workpiece.

7. The turnover mechanism as claimed in claim 6, wherein the second rotary driver comprises a main body and a support member positioned on the main body, the two second clamping members are positioned on the support member, and the second clamping driver is positioned on the support member adjacent to the two second clamping members.

8. The turnover mechanism as claimed in claim 7, wherein each second clamping member comprises a rod and a clamping jaw connected to the rod; the ends of the two second clamping members away from the clamping jaws are positioned on the support member adjacent to the main body of the second rotary driver; the end of the clamping jaw away from the rod reaches beyond the support member, and above the first turning mechanism.

9. The turnover mechanism as claimed in claim 1, wherein the turnover mechanism further comprises a conveyor belt, the conveyor belt is positioned on the support bracket and below the first clamping member.

10. The turnover mechanism as claimed in claim 1, wherein the turnover mechanism further comprises a controller electrically connected with the first turning mechanism, the movement mechanism and the second turning mechanism.
